(19) United States
(12) Patent Application Publication
(10) Pub. No.: US 2026/0155407 A1
(43) Pub. Date: Jun. 4, 2026

(54) HYBRID COOLING SYSTEM FOR FUEL CELL

(71) Applicant: FORD GLOBAL TECHNOLOGIES, LLC, Dearborn, MI (US)

(72) Inventors: Hassan Farhat, Dearborn, MI (US); William F. Sanderson, JR., Commerce Twp, MI (US)

(21) Appl. No.: 18/966,640

(22) Filed: Dec. 3, 2024

(51) Int. Cl. H01M 8/04007; H01M 8/04029; H01M 8/04701; H01M 8/04746

(52) U.S. Cl. CPC H01M 8/04059; H01M 8/04029; H01M 8/04074; H01M 8/04723; H01M 8/04768

(57) ABSTRACT

A hybrid cooling system for a fuel cell vehicle utilizes evaporative cooling to supplement a radiator. Liquid water produced by the fuel cell is utilized by the evaporative cooling system. A vacuum pump lowers a pressure in a chiller to increase the rate of evaporation of the liquid water. A control system manages capture of liquid water during periods of low fuel cell power demand for use during periods of high fuel cell power demand.

### TECHNICAL FIELD

This disclosure pertains to a hybrid cooling system for a vehicle fuel cell. In particular, this disclosure pertains to use of evaporative cooling to supplement a radiator.

### BACKGROUND

The amount of power demanded by a vehicle varies over time. During acceleration of hill climbing, a high amount of power is required for propulsion. The propulsion system should be designed to produce this amount of power. However, steady state operations generally require only a small fraction of this amount of power.

### SUMMARY

A fuel cell cooling system includes a fuel cell, a water storage tank, a chiller, a coolant pump, and a vacuum pump. The fuel cell is configured to generate electricity and produce water. The fuel cell has a coolant inlet and a coolant outlet. The water storage tank is configured to store liquid water produced by the fuel cell. The chiller is configured to receive liquid water from the water storage tank and to remove heat from a coolant via evaporation of the liquid water. The coolant pump is configured to circulate the coolant from the coolant outlet, through the chiller, to the coolant inlet. The vacuum pump is configured to reduce a pressure in the chiller to facilitate the evaporation of the liquid water. A water control valve may be configured to control a flow rate of liquid water from the water tank to the chiller. A separator may be configured to separate liquid water from water vapor and route the liquid water to the water storage tank. A separator bypass valve may selectively route the water produced by the fuel cell to the separator. A water drain valve may selectively empty liquid water from the water storage tank, bypassing the chiller. A radiator may remove heat from the coolant via convection to ambient air. A selector valve may selectively route a fraction of the coolant flow from the coolant outlet to the coolant inlet through the chiller, a remainder of the coolant flow being routed through the radiator.

A method of controlling a fuel cell cooling system includes routing coolant from a coolant outlet of a fuel cell, through a chiller, to a coolant inlet of the fuel cell. In response to a coolant temperature exceeding a first threshold, liquid water is released from a water storage tank into the chiller. A vacuum pump is used to reduce a pressure in the chiller to evaporate the liquid water to remove heat from the coolant. A rate at which the liquid water is released into the chiller may be controlled based on a pressure in the chiller. The pressure in the chiller may be controlled to a target pressure which is based on a temperature of the coolant. Water produced by the fuel cell may be routed to a separator. Liquid water from the separator may be routed to the water storage tank. Coolant from the coolant outlet of the fuel cell may be routed through a radiator, to the coolant inlet of the fuel cell, bypassing the chiller. Liquid water from the water storage tank may be emptied in response to an ambient temperature being less than a second threshold.

A vehicle includes a fuel cell, a coolant pump, a water storage tank, and a controller. The fuel cell generates electricity and produces water. The fuel cell has a coolant inlet and a coolant outlet. The coolant pump circulates a coolant from the coolant outlet, through a chiller, to the coolant inlet. The water storage tank stores liquid water produced by the fuel cell. The controller is programmed to, in response to a first temperature of the coolant exceeding a first threshold, release liquid water from the water storage tank into the chiller and command a vacuum pump to reduce a pressure in the chiller to evaporate the liquid water to remove heat from the coolant. A separator may separate liquid water from the water produced by the fuel cell and route the liquid water to the water storage tank. The controller may be programmed to bypass the separator in response to a water level in the water storage tank exceeding a second threshold. The controller may also be programmed to adjust a rate at which the liquid water is released into the chiller based on a pressure in the chiller and a second temperature of the coolant. A drain valve may empty liquid water from the water storage tank in response to an ambient temperature being less than a third threshold. The controller may also be programmed to route a variable fraction of a coolant flow rate through the radiator, bypassing the chiller, based on a third temperature of the coolant.

### BRIEF DESCRIPTION OF THE DRAWINGS

FIG. 1 is a schematic diagram of a fuel cell vehicle.

FIG. 2 is a schematic diagram of a fuel cell cooling system suitable for use in the fuel cell vehicle of FIG. 1.

FIG. 3 is a cross section of a chiller suitable for use in the fuel cell cooling system of FIG. 2.

FIG. 4 is a flowchart for a process to control the fuel cell cooling system of FIG. 2 while the vehicle is operating.

FIG. 5 is a flowchart for a process to control the fuel cell cooling system of FIG. 2 while the vehicle is not operating.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

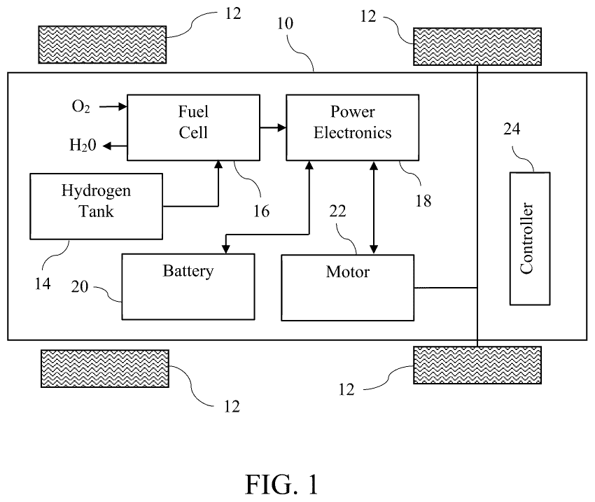

FIG. 1 illustrates some of the components of a hydrogen fuel cell vehicle 10. The illustrated vehicle has four wheels of which at least two are drive wheels. Hydrogen fuel (H₂) is stored in a hydrogen storage tank 14. The hydrogen is fed to a fuel cell where it combines with Oxygen (O₂) to form water (H₂O) and electricity. The Oxygen may come from ambient air which is a mixture of Nitrogen (N₂), Oxygen, and small amounts of many other substances. The Nitrogen and other substances may be exhausted from the fuel cell along with the water. In this document, the term “water” without a modifier refers to any form of H₂O, including ice, liquid water, water vapor, and mixtures of the above. The electrical energy produced by the fuel cell flows into power electronics 18, which conditions it and routes it to a battery 20 and/or an electric motor 22. The motor converts the electrical power to mechanical power which is directed to the drive wheels. At times, electrical energy may flow into battery 20 while at other times, electrical energy may flow from battery 20. Similarly, electrical energy may flow into motor 22 when needed to propel the vehicle and may flow from the motor during regenerative braking. Controller 24 may manipulate actuators of the above components and other discussed below based on inputs from sensors and from a vehicle operator. Some of the algorithms employed by controller 24 are discussed in detail below.

Fuel cell cooling is very challenging due to low initial temperature difference (ITD=Coolant inlet temperature−Air inlet temperature). This necessitate the use of a big radiator, which size may be constrained by the vehicle frontal area. To fill the gap, a complementary two-phase cooling system using the fuel cell exhaust water is proposed. The exhaust water is routed via a heat exchanger (chiller) where a vacuum pump is used to force the water to evaporate at the incoming coolant temperature from the fuel cell stacks to chill the coolant, thus providing additional cooling capacity to the system. At low loads the complementary cooling is not needed, while the fuel cell exhaust is mainly composed of water in liquid form. At high loads the additional cooling is needed while the fuel cell exhaust water is mainly in vapor form and not useful. Therefore, a tank is used to store the exhaust water when available, such that it will eventually be delivered to the chiller when needed during high load maneuvers.

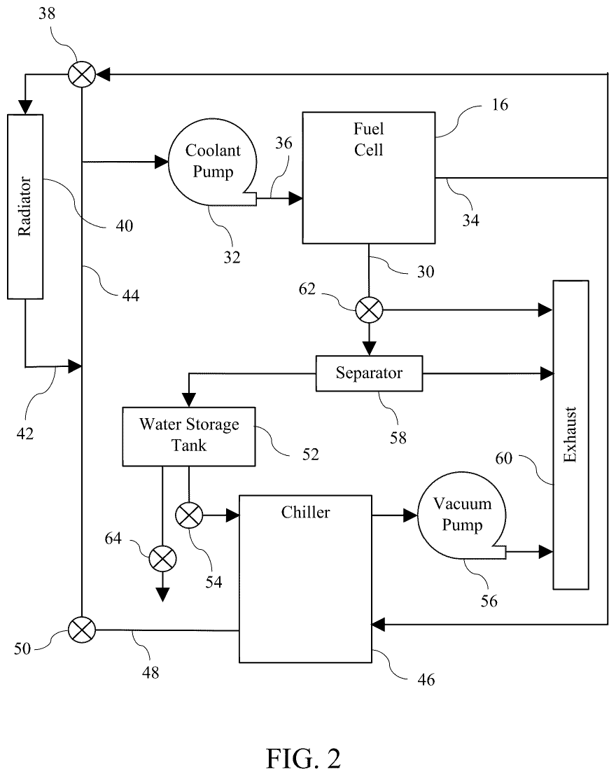

FIG. 2 is a schematic diagram of a fuel cell cooling system suitable for use in the vehicle of FIG. 1. The diagram is intended to convey connections between components but not sizes, shapes, or relative physical positions of components. The Hydrogen inlet and the electrical connections of fuel cell 16 are omitted in FIG. 2. The exhaust water from fuel cell 16 is expelled via tube 30. Coolant pump 32 pumps a coolant from coolant outlet 34 of the fuel cell to coolant inlet 36 of the fuel cell. Internally to the fuel cell, the coolant flows from the coolant inlet 36 to the coolant outlet 34 absorbing heat to maintain an internal temperature of the fuel cell in an acceptable range. The amount of heat that must be absorbed varies depending upon operating conditions. When the fuel cell is called upon to generate a high level of electrical energy, the rate at which heat must be removed increases.

The coolant is pumped from the fuel cell outlet to the fuel cell inlet via one or more of three possible routes. Bypass valve 38 may be a two-position selection valve which routes coolant either through radiator 40 to radiator outlet 42 or directly back to the pump inlet 44. In some embodiments, bypass valve may be a proportional valve which divides the flow in a controlled manner between these two paths. A portion of the flow may be directed through chiller 46 to chiller outlet 48. Selector valve 50 may be a proportional valve which controls what proportion of the flow into pump inlet 44 comes from chiller outlet 48 with the remainder coming from radiator outlet 42. In some embodiments, valve 50 may act as an on-off valve to block all coolant flow to the chiller 46. For example, the flow rate through radiator 40 may nominally be about 320 liters per minute, while the flow rate through chiller 46 may range from zero to about 20 liters per minute.

Radiator 40 removes heat from the coolant to ambient air via convection. A fan may force the ambient air through the fins of radiator 40. The amount of heat removed from the coolant as it passes through the radiator depends on the ambient air temperature, the temperature of the coolant entering the radiator, the flow rate of the coolant through the radiator, the flow rate of air through the radiator, and the radiator size. The radiator may be sized such that it is capable of rejecting the heat generated by fuel cell 16 and returning the coolant at an acceptable temperature during most operating conditions but not during periods in which fuel cell 16 is operated at its highest rated output.

Chiller 46 removes heat from the coolant via evaporative cooling. As described below, liquid water from water storage tank 52 is dripped onto coils at a rate controlled by water control valve 54. Vacuum pump 56 creates a lower than atmospheric pressure within chiller 46 thereby lowering the boiling point of water within the chiller. This causes the liquid water to evaporate far more rapidly than it would at atmospheric pressure. As the liquid water evaporates, it absorbs heat from the coolant flowing through chiller 46. The coolant emerges into chiller outlet 48 at a lower temperature than when it entered the chiller. The cooling capacity of the chiller 46 supplements the cooling capacity of radiator 40 when the fuel cell is operating at or near is rated output.

Water storage tank 52 is filled using liquid water produced by fuel cell 16. The exhaust from fuel cell 16 may contain a mixture of liquid water, water vapor, and other gaseous compounds. Separator 58 separates the liquid water from the gaseous constituents and routes the liquid water to water storage tank 52 while sending the gaseous constituents to exhaust manifold 60 from which they are directed to the environment. In the illustrated embodiment, gravity causes water to flow from the separator to the water storage tank. In alternative embodiments, a small pump may be used so that the water storage tank can be located higher than the separator. To avoid overfilling the water storage tank, separator bypass valve 62 may divert the exhaust directly to the exhaust manifold when the water storage tank is full. Drain valve 64 may be used to drain liquid water from water storage tank 52 when ambient temperature is near or below freezing, to avoid damage from water expanding as it freezes in the tank. In alternative embodiments, drain valve 64 could also be used in lieu of separator bypass valve 62 to avoid overfilling water storage tank 52.

In the embodiment of FIG. 2, coolant flows through the radiator and the chiller in parallel during periods of high cooling demand. In other words, the coolant flow is divided with a fraction (usually less than 10%) flowing through the chiller and the remainder flowing through the radiator. Selector valve 50 limits the flow through the cooler when evaporative cooling is not required. Selector valve 50 may be an on-off valve that limits the flow to zero when evaporative cooling is not required. In other embodiments, the relative magnitude could be controlled by a valve at the point where the two flow streams split. In still other embodiments, the coolant could flow through the radiator and the chiller in series.

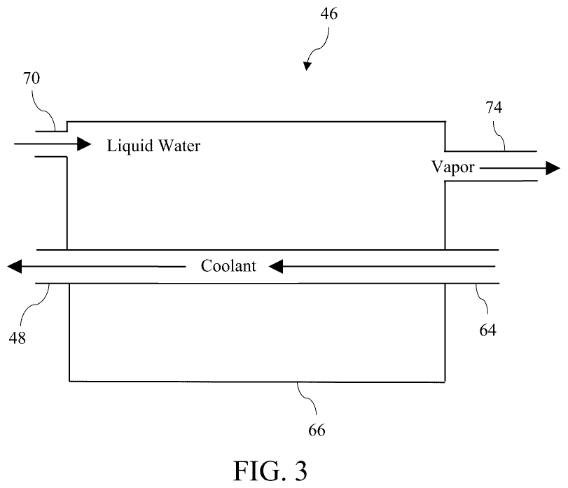

FIG. 3 illustrates chiller 46, which is a forced convection refrigerant to coolant heat exchanger where water acts as the refrigerant. The chiller may be a cross flow heat exchanger, where the hotter coolant inlet meets the exiting vapor/liquid water to ensure full vaporization of the water, leading to best cooling performance. The chiller water section is connected to the vacuum pump 56 by a vapor port 74. Careful control of the vacuum pump 56 speed and the position of the proportional valve 54 provides low pressure in the interior of the chiller such that the coolant temperature entering the chiller is reasonably above the water saturation temperature at the chiller pressure. The liquid water rapidly evaporates. As it evaporates, it absorbs heat from the coolant.

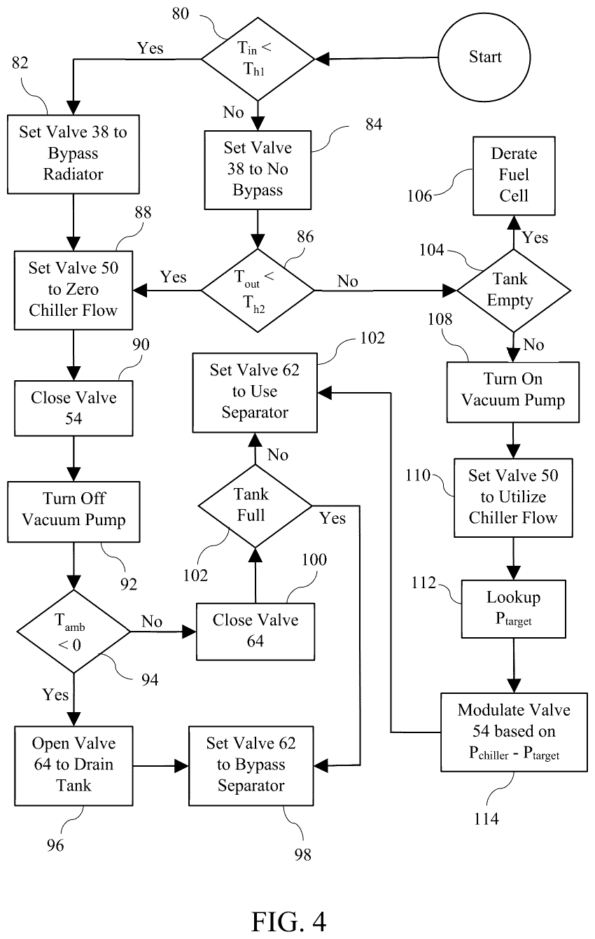

FIG. 4 is a flowchart for a process to control the fuel cell cooling system of FIG. 2. This process is executed at regular intervals while the vehicle is operating by a controller such as controller 24. For example, the process may be executed in response to interrupt signals every 100 milliseconds. In some embodiments, the process may be divided into separate sub-processes that are executed independently but may share data. Independent sub-processes may be executed on a single controller or on separate cooperating controllers. Operations may be performed in a different order than indicated in FIG. 4.

At 80, the controller checks whether the temperature of the coolant at the fuel cell inlet, Tᵢₙ, is less than a first threshold temperature Tₕ₁. Tₕ₁ is a calibratable value indicating the lower endpoint of a normal operating range of coolant temperatures. Thresholds such as Tₕ₁ may be constants or may be calculated values that vary based on conditions. If Tᵢₙ<Tₕ₁, then bypass valve 38 is set at 82 to direct the coolant from the fuel cell outlet directly back to the coolant pump, bypassing the radiator. This action decreases the time required for the coolant to warm up into the normal operating range. If Tᵢₙ>=Tₕ₁, then bypass valve 38 is set at 84 to direct the coolant through the radiator.

At 86, the controller checks whether the temperature of the coolant at the fuel cell outlet, Tₒᵤₜ, is less that a second threshold temperature Tₕ₂. Tₕ₂ is a calibratable value indicating the upper endpoint of the normal operating range of coolant temperatures, beyond which the fuel cell may be derated. If Tₒᵤₜ<Tₕ₂, then the controller takes a series of actions such that the chiller is not utilized for cooling. (The controller may also check whether there is an opportunity for parasitic load reduction predicted by the vehicle connectivity system. Through vehicle connectivity and knowledge of the drive cycle, the controller may elect to still use evaporative cooling at relatively moderate cooling loads with Tout<Th, if the power consumption of the vacuum pump is lower than that of the radiator fans.) If the controller previously determined at 80 that Tᵢₙ<Tₕ₁, then the controller can proceed with these actions without separately checking whether Tₒᵤₜ<Tₕ₂. At 88, the controller sets selector valve 50 to block all coolant flow through the chiller. At 90, the controller closes water control valve 54 such that no water is released into the chiller from the water storage tank. At 92 vacuum pump 56 is turned off.

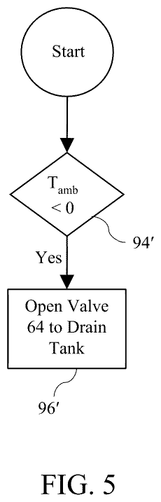

At 94, the controller checks whether the ambient temperature, T_{amb}, is less than the freezing point of water. The threshold may be offset slightly from the freezing point to provide some margin of safety. If so, drain valve 64 is opened at 96 to drain the liquid water from the water storage tank. If liquid water were retained at below freezing temperatures, it could freeze which could cause issues due to the expansion as liquid water forms into ice. Also, separator bypass valve 62 is closed such that no additional liquid water is routed to the water storage tank. If the temperature is above freezing at 94, the controller closes valve 64 at 100. The risk of water freezing in the water storage tank is not limited to the times when the vehicle is operating. FIG. 5 is a flowchart for a companion process which is executed periodically when the vehicle is not operating. In some embodiments, drain valve 64 may be passively controlled by a thermostat as opposed to being actively controlled by the controller.

At 102, the controller checks whether the water storage tank 52 is full. If so, the controller closes valve 64 at 100 to prevent overfilling it. If not, the controller opens valve 64 at 104. When valve 64 is open, water produced by the fuel cell flows to separator 58 where the liquid water is separated from other exhaust constituents and directed into the water storage tank 52. In alternative embodiments, overfilling could be avoided by controlling drain valve 64 or by a passive overflow tube.

If the controller determines, at 86, that Tₒᵤₜ>=Tₕ₂, then the controller takes a series of actions to operate the evaporative cooling system to supplement the capacity of the radiator. At 104, the controller checks whether water storage tank 52 is empty. If so, then the evaporative cooling system is not capable of providing supplemental cooling, so the fuel cell must be operated at limited capacity at 106. If liquid water is available, the controller turns on the vacuum pump at 108, which reduces the pressure in the sealed housing of the chiller. At 110, the controller sets selector valve 50 to allow coolant to flow through the chiller. At 112, the controller looks up a target pressure, P_{target}, in a calibration table based on the chiller inlet coolant temperature. Lower inlet coolant temperatures result in lower target pressures, i.e., more demand from vacuum pump 56 and higher restriction from valve 54. At 114, water control valve 54 is controlled in closed loop manner based on the difference between a measured chiller pressure, P_{chiller}, and the target pressure P_{target}, yielding a lower saturation temperature by a good margin than the coolant inlet temperature. This difference represents the error term of the closed loop control scheme. If the measured pressure is higher than the target pressure, then the valve is set to reduce the flow rate of water giving the vacuum pump an opportunity to bring the chiller pressure down. If the measured pressure is less than the target pressure, then the valve is set to increase the flow rate of water, thus allowing the actual pressure to match the target pressure. While the evaporative cooling is being utilized, valve 62 is open at 102 to allow additional water to flow into the water storage tank. However, when the fuel cell is operating above its normal operating temperature range, most of the water produced is in vapor form. The system relies primarily on liquid water that was captured during previous operating conditions.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A fuel cell cooling system, comprising:
a fuel cell configured to generate electricity and produce water, the fuel cell having a coolant inlet and a coolant outlet;
a water storage tank configured to store liquid water produced by the fuel cell;
a chiller configured to receive liquid water from the water storage tank and to remove heat from a coolant via evaporation of the liquid water;
a coolant pump configured to circulate the coolant from the coolant outlet, through the chiller, to the coolant inlet; and
a vacuum pump configured to reduce a pressure in the chiller to facilitate the evaporation of the liquid water.

2. The fuel cell cooling system of claim 1 further comprising a water control valve configured to control a flow rate of liquid water from the water storage tank to the chiller.

3. The fuel cell cooling system of claim 1 further comprising a separator configured to separate liquid water from water vapor and route the liquid water to the water storage tank.

4. The fuel cell cooling system of claim 3 further comprising a separator bypass valve configured to selectively route the water produced by the fuel cell to the separator.

5. The fuel cell cooling system of claim 1 further comprising a water drain valve configured to selectively empty liquid water from the water storage tank, bypassing the chiller.

6. The fuel cell cooling system of claim 1 further comprising a radiator configured to remove heat from the coolant via convection to ambient air.

7. The fuel cell cooling system of claim 6 further comprising a selector valve configured to selectively route a fraction of the coolant from the coolant outlet to the coolant inlet through the chiller, a remainder of the coolant being routed through the radiator.

8. A method of controlling a fuel cell cooling system comprising:
routing coolant from a coolant outlet of a fuel cell, through a chiller, to a coolant inlet of the fuel cell; and
in response to a coolant temperature exceeding a first threshold, releasing liquid water from a water storage tank into the chiller and using a vacuum pump to reduce a pressure in the chiller to evaporate the liquid water to remove heat from the coolant.

9. The method of claim 8 wherein a rate at which the liquid water is released into the chiller is controlled based on a pressure in the chiller.

10. The method of claim 9 wherein the pressure in the chiller is controlled to a target pressure which is based on a temperature of the coolant.

11. The method of claim 8 further comprising routing water produced by the fuel cell to a separator and routing liquid water from the separator to the water storage tank.

12. The method of claim 8 further comprising routing coolant from the coolant outlet of the fuel cell, through a radiator, to the coolant inlet of the fuel cell, bypassing the chiller.

13. The method of claim 8 further comprising emptying liquid water from the water storage tank in response to an ambient temperature being less than a second threshold.

14. A vehicle comprising:
a fuel cell configured to generate electricity and produce water, the fuel cell having a coolant inlet and a coolant outlet;
a coolant pump configured to circulate a coolant from the coolant outlet, through a chiller, to the coolant inlet;
a water storage tank configured to store liquid water produced by the fuel cell; and
a controller programmed to, in response to a first temperature of the coolant exceeding a first threshold, release liquid water from the water storage tank into the chiller and command a vacuum pump to reduce a pressure in the chiller to evaporate the liquid water to remove heat from the coolant.

15. The vehicle of claim 14 further comprising a separator configured to separate liquid water from the water produced by the fuel cell and route the liquid water to the water storage tank.

16. The vehicle of claim 15 wherein the controller is programmed to bypass the separator in response to a water level in the water storage tank exceeding a second threshold.

17. The vehicle of claim 14 wherein the controller is further programmed to adjust a rate at which the liquid water is released into the chiller based on a pressure in the chiller and a second temperature of the coolant.

18. The vehicle of claim 14 further comprising a drain valve configured to empty liquid water from the water storage tank in response to an ambient temperature being less than a third threshold.

19. The vehicle of claim 18 further comprising a radiator and wherein the controller is further programmed to route a variable fraction of a coolant flow rate through the radiator, bypassing the chiller, based on a third temperature of the coolant.
